(19) United States
(12) Patent Application Publication
(10) Pub. No.: US 2013/0293124 A1
(43) Pub. Date: Nov. 7, 2013

(54) SYSTEM FOR GENERATING LIGHT HAVING A CONSTANT COLOR TEMPERATURE AND ASSOCIATED METHODS

(71) Applicant: LIGHTING SCIENCE GROUP CORPORATION, Satellite Beach, FL (US)

(72) Inventors: Fredric S. Maxik, Indialantic, FL (US); David E. Bartine, Cocoa, FL (US); George Du, Rockledge, FL (US); Robert R. Soler, Cocoa Beach, FL (US); Eliza Katar Grove, Satellite Beach, FL (US)

(73) Assignee: LIGHTING SCIENCE GROUP CORPORATION, Satellite Beach, FL (US)

(21) Appl. No.: 13/737,581

(22) Filed: Jan. 9, 2013

Related U.S. Application Data
(63) Continuation-in-part of application No. 13/722,581, filed on Dec. 20, 2012.
(60) Provisional application No. 61/643,726, filed on May 7, 2012.

(51) Int. Cl. H05B 33/08

(52) U.S. Cl. CPC H05B 33/0854
USPC 315/186

(57) ABSTRACT

A lighting system and method for maintaining constant color output. The lighting system may include a first light-emitting diode (LED) configured to emit a first color, a second LED configured to emit a second color, control circuitry configured to control the operation of the first LED, and a temperature sensor positioned in thermal communication with at least one of the first LED and the second LED and in electrical communication with the control circuitry. The luminous intensity of the second LED may vary with temperature. The control circuitry may be configured to control the luminous intensity of the first LED responsive to a temperature indication from the temperature sensor.

### RELATED APPLICATIONS

This application is a continuation-in-part of U.S. patent application Ser. No. 13/722,581 filed Dec. 20, 2012, titled Constant Current Pulse-Width Modulation Lighting System and Associated Methods, which in turn claims benefit under 35 U.S.C. §119(e) of U.S. Provisional Patent Application Ser. No. 61/643,726, filed May 7, 2012.

### FIELD OF THE INVENTION

The present invention relates to systems and methods for maintaining a constant color temperature when using light emitting diodes (LEDs) that produce light having a varying luminous intensity.

### BACKGROUND OF THE INVENTION

Light emitting diodes (LEDs) are quickly being adopted as a light source in commercial lighting systems. Additionally, lighting systems utilizing LEDs of various colors are gaining in popularity due to their favorable lighting characteristics, including color rendering index (CRI), color temperature, and other aspects of lighting. More information regarding color mixing of LEDs of various colors may be found in U.S. patent application Ser. No. 13/107,927 titled High Efficacy Lighting Signal Converter and Associated Methods filed May 15, 2011, the content of which is incorporated herein by reference. However, LEDs are known to suffer from a decrease in luminous intensity of light emitted thereby when the temperature of the LED is increased. Moreover, different LEDs composed of different materials and emitting different colors have different degradations in performance. In order to maintain the desired levels of constituent colors in a lighting system utilizing LEDs of various colors, this degradation in performance must be accommodated. Currently, this involves the use of contemplated software and electrical components. Therefore, there is a need to provide a simple and low-cost solution to matching the decrease in some LEDs of a lighting system resulting from increased temperature.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the foregoing in mind, embodiments of the present invention are related to a lighting system for maintaining constant color output. The lighting system may include a first light-emitting diode (LED) configured to emit a first color, a second LED configured to emit a second color, control circuitry configured to control the operation of the first LED, and a temperature sensor positioned in thermal communication with at least one of the first LED and the second LED and in electrical communication with the control circuitry. The first and second LEDs may be in a serial electrical connection with each other. Additionally, the luminous intensity of the second LED may vary with temperature. Furthermore, the control circuitry may be configured to control the luminous intensity of the first LED responsive to a temperature indication from the temperature sensor.

Another embodiment of the present invention is directed to a method of maintaining a constant color output in a lighting system having a first LED configured to emit a first color, a second LED configured to emit a second color, control circuitry configured to control the operation of the first LED, and a temperature sensor positioned in thermal communication with at least one of the first LED and the second LED and positioned in electrical communication with the control circuitry. The method may comprise the steps of measuring a first temperature using the temperature sensor, operating each of the first LED and the second LED, measuring a second temperature using the temperature, and determining whether there is a change in temperature between the first and second temperatures. A determination of a change in temperature may result in operating the first LED responsive to the change in temperature.

Another embodiment of the present invention is directed to a lighting system for maintaining constant color output. The lighting system may include a first light-emitting diode (LED) configured to emit a first color, a second LED configured to emit a second color, a circuit board positioned in electrical and thermal communication with each of the first and second LEDs, a temperature sensor positioned in thermal communication with at least one of the first LED, the second LED, and the circuit board, control circuitry positioned in electrical communication with the temperature sensor and comprising a timer configured to receive an input signal from the temperature sensor indicating the temperature of at least the first LED and to generate a signal controlling the operation of the first LED responsive to the input signal. The first and second LEDs may be in a serial electrical connection with each other. Additionally, the luminous intensity of second LED may decrease predictably with an increase in temperature. Furthermore, the control circuitry may be configured to decrease the luminous output of the first LED proportionally to a predicted decrease in luminous output of the second LED resulting from an increase in temperature indicated by the temperature sensor. Yet further, the control circuitry may be configured to control the luminous intensity of the first LED responsive to a temperature indication from the temperature sensor.

### BRIEF DESCRIPTION OF THE DRAWINGS

FIG. 1a is a schematic diagram of a lighting system according to an embodiment of the invention.

FIG. 1b is a schematic diagram of the lighting system of FIG. 1a further including a plurality of blue LEDs.

FIG. 2 is a schematic diagram of a lighting system according to another embodiment of the invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

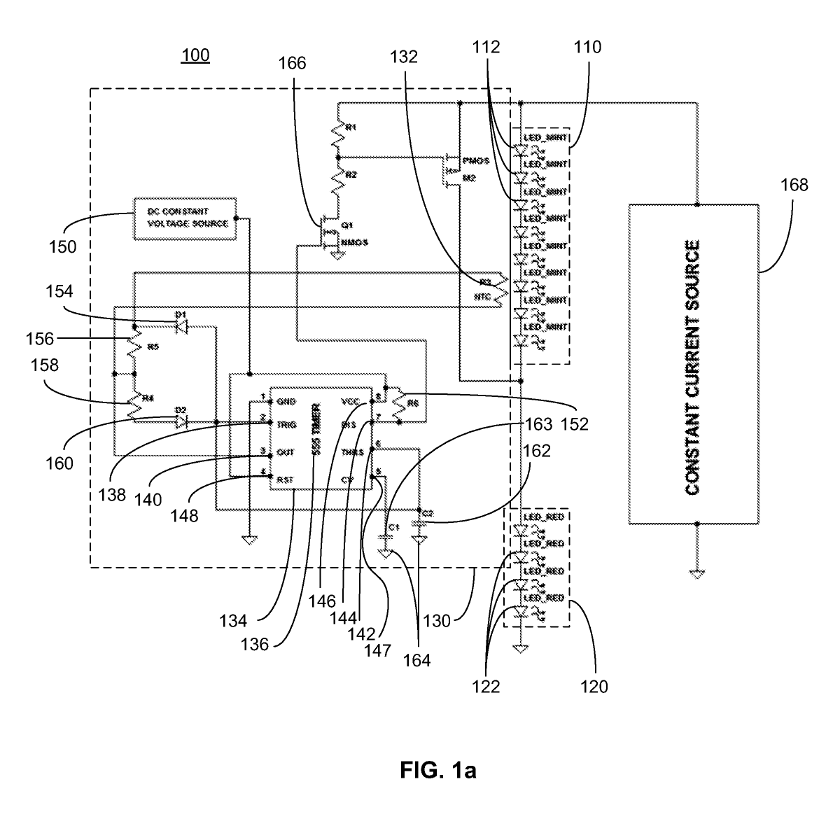

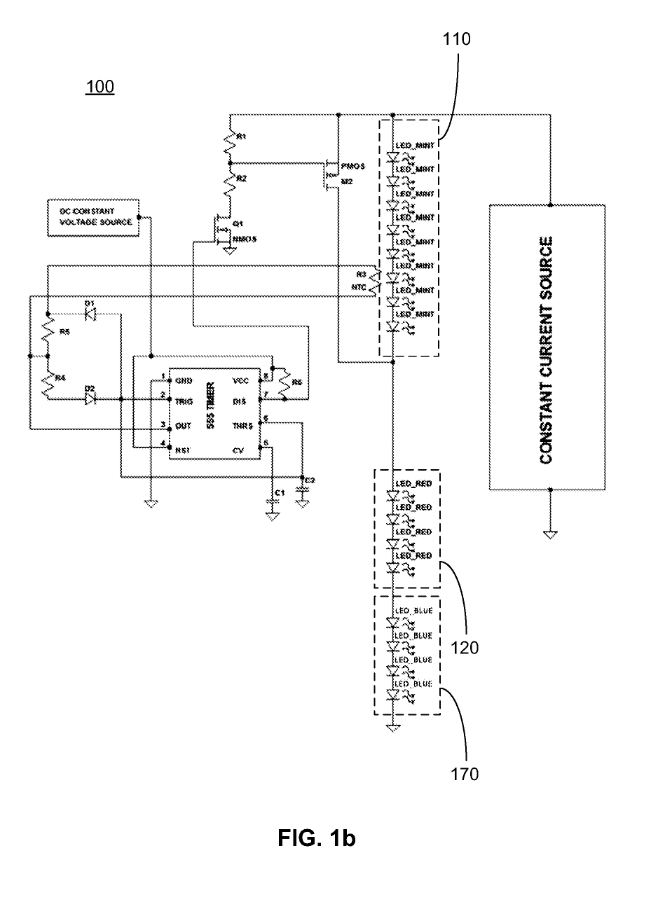

An embodiment of the invention, as shown and described by the various figures and accompanying text, provides a lighting system 100, as shown in FIG. 1a. The lighting system 100 may include a first light source 110 and a second light source 120. Each of the first light source 110 and the second light source 120 may comprise any light emitting element, including, but not limited to, incandescent lights, fluorescent lights, light emitting semiconductors, such as light emitting diodes (LEDs) including organic LEDs, halogen lights, arc lights, and any other light emitting element known in the art. In the present embodiment, the first light source 110 comprises a first plurality of LEDs 112 and the second light source 120 comprises a second plurality of LEDs 122.

In some embodiments, the first plurality of LEDs 112 may be operable to emit light within a first wavelength range. Additionally, the first plurality of LEDs 112 may be operable to polychromatic light. The light emitted by the first plurality of LEDs 112 may be associated with a color. In some embodiments, the first plurality of LEDs 112 may emit a light that is mint white in color. Moreover, in some embodiments, the first plurality of LEDs 112 may be high efficiency LEDs, high efficacy LEDs, or both.

In some embodiments, the second plurality of LEDs 122 may be operable to emit light within a second wavelength. Moreover, the second wavelength may be associated with a color. In some embodiments, the second plurality of LEDs 122 may be LEDs that emit light having a luminous intensity that varies with the temperature of the LED. For example, it is known that the luminous intensity of light emitted by red LEDs reduces with an increase in temperature. Accordingly, the second plurality of LEDs 122 may be red LEDs that vary responsive to changes in temperature of the second plurality of LEDs 122 in a known, predictable manner.

The first plurality of LEDs 112 may be configured to be electrically connected in series. Similarly the second plurality of LEDs 122 may be configured to be electrically connected in series. Moreover, the first light source 110 may be serially electrically connected to the second light source 120. More detail on the electrical connection of the first light source 110 and the second light source 120 may be found in U.S. patent application Ser. No. 13/722,581 titled Constant Current Pulse-Width Modulation Lighting System and Associated Methods, the contents of which are incorporated by reference herein.

In some embodiments, the lighting system 100 may include one or more additional light sources. The additional light sources may be configured similarly to one or both of the first light source 110 and the second light source 120. For example, referring now to FIG. 1 b, the additional light sources may include a plurality of LEDs 170. Moreover, the additional light sources may be configured to emit light having a wavelength range associated with any color in the visible spectrum, as is understood in the art. In some embodiments, the lighting system 100 may include a third LED positioned in electrical series with either of the first light source 110 and the second light source 120. In some of those embodiments, the LED may be a blue LED. In some embodiments, the lighting system may include a plurality of blue LEDs positioned electrically in series with either of the first light source 110 and the second light source 120. Moreover, some embodiments may further include a color conversion layer, as described in U.S. patent application Ser. No. 13/234,371 titled Color Conversion Occlusion and Associated Methods filed Sep. 16, 2011, U.S. patent application Ser. No. 13/305,434 titled Remote Lighting Device and Associated Methods filed Nov. 28, 2011, and U.S. patent application Ser. No. 13/234,604 titled Remote Light Wavelength Conversion Device and Associated Methods, the contents of which are incorporated by reference herein. Moreover, the conversion color layer may be positioned in optical communication with the blue LED 170 shown in FIG. 1b and emit a green light. Additionally, the lighting system 100 may include a plurality of light sources each emitting light within one or more wavelength ranges so as to create a polychromatic light having multiple constituent lights within a light spectrum. More details around the spectrum of light included in such polychromatic lights may be found in U.S. patent application Ser. No. 13/681,522 titled Illumination and Grow Light System and Associated Methods filed Nov. 20, 2012, the content of which is incorporated by reference herein.

The lighting system 100 may further include control circuitry 130. The control circuitry 130 may include any electrical component that facilitates the operation of the first light source 110 and the second light source 120. The control circuitry 130 may be configured to control the operation of the first light source 110, the second light source 120, or both. Moreover, the control circuitry 130 may be configured to control the operation of the first light source 110 responsive to the operation of the second light source 120. More specifically, the control circuitry 130 may be configured to control the operation of the first light source 110 responsive to changes in the luminous intensity of light emitted by the second light source 120. For example, the control circuitry 130 may be configured to control the operation of the first light source 110 so as to alter the luminous intensity of light emitted by the first light source 110 responsive to changes in temperature of second light source 120. The control circuitry 130 may be configured to determine an approximate luminous intensity of light emitted by the second light source 120 from a determined temperature of the second light source 120 and alter the luminous intensity of light emitted by the first light source 110 accordingly.

In some embodiments, the control circuitry 130 may include a temperature sensor 132. The temperature sensor 132 may be any device that is responsive to changes in temperature and operable to measure and/or be responsive to the temperature of a thermally coupled structure and changes in temperature. The temperature sensor 132 may be, for example, a thermistor, an integrated circuit sensor, or a thermocouple. This list is exemplary only, and all suitable devices known in the art are contemplated and included within the scope of the invention. The temperature sensor 132 may be positioned in thermal communication with the at least one of the first light source 110 and the second light source 120. Where the temperature sensor 132 is in thermal communication with the first light source 110, the temperature of the first light source 110 may be used to approximate the temperature of the second light source 120. Furthermore, in some embodiments, the lighting system 100 may further include a circuit board to which the first light source 110, the second light source 120, and the temperature sensor 132 are all in thermal communication therewith. In such embodiments, the temperature sensor 132 may be responsive to changes in temperature of the circuit board, which may approximate the changes in temperature of the second light source 120.

In some embodiments, the control circuitry 130 may further include an integrated circuit (IC) 134. The IC 134 may be positioned in electrical communication with each of the first light source 110, the second light source 120, and the temperature sensor 132. The IC 134 may be configured to generate an output signal that controls the operation of at least the first light source 110, but may also control the operation of the second light source 120 as well as any other light source of the lighting device 100. Furthermore, in some embodiments, the IC 134 may be one selected for its low cost. In some embodiments, the IC 134 may be a timer 136, for example, a 555 timer, as is known in the art.

The IC 134 may be configured to receive indications of temperature from the temperature sensor 132 and operate any of the light sources of the lighting device 100, for example, the first light source 110, responsive to those indications of temperature. For example, the IC 134 may measure a first temperature using the temperature sensor 132 and operate the first light source 110 responsive to the first temperature. The IC 134 may then measure a second temperature using the temperature sensor 132 and determine whether the second temperature is different from the first temperature, indicating a change in temperature. If there has been a change, the IC 134 may change the operational characteristics of the first light source 110 responsive to the change in temperature. For example, the IC 134 may alter the operation of the first light source 110 so as to change the luminous intensity of light emitted thereby.

The timer 136 may include an oscillation cycle. The oscillation cycle may be functionally coupled to the first light source 110 such that the first light source 110 operates responsive to the oscillation cycle. The timer 136 may be configured to receive as an input an electrical signal from the temperature sensor 132. The timer 136 may alter the oscillation cycle responsive to the input signal received from the temperature sensor 132, thereby altering the operation of the first light source 110.

Providing further detail, the timer 136 may include a trigger pin 138, an output pin 140, a threshold pin 142, a discharge pin 144, a V_{c}, pin 146, a control voltage pin 147, and a reset pin 148. Each of the V_{c}, pin 146 and the reset pin 148 may be electrically coupled to a DC constant current voltage source 150. Furthermore, the discharge pin 144 may be electrically coupled to the DC constant current voltage source 150 via a first resistor 152. The output pin 140 may be electrically coupled with the temperature sensor 132, which may then be serially electrically connected to a first diode 154 and a second resistor 156. Furthermore, the output pin 140 may additionally be electrically connected to each of the second resistor 156 and a third resistor 158, which is in turn serially electrically connected to a second diode 160. Furthermore, the trigger pin 138 may be electrically connected with each of the first diode 154 and the second diode 160, each of which is positioned such that their forward orientation is opposite each other. The threshold pin 142 may similarly be electrically connected with each of the first diode 154 and the second diode 160, as well as to a first capacitor 162 which is serially connected with a ground 164. The control voltage pin 147 may similarly be connected to a second capacitor 163 that is serially connected to ground 164.

The discharge pin 144 may be electrically coupled to circuitry resulting in the first light source 110 operating responsive to a signal generated by the timer 136 and transmitted through the discharge pin 144. The signal generated by the timer 136 may be the oscillation cycle described hereinabove. In some embodiments, the discharge pin 144 may be electrically connected with a first metal-oxide semiconductor field-effect transistor (MOSFET) 166. More specifically, the discharge pin 144 may be electrically connected to the gate of the first MOSFET 166. Accordingly, current may flow through the first MOSFET 166 responsive to the signal transmitted through the discharge pin 144. The lighting system 100 may further include electrical components enabling the PWM dimming of the first light source 110 using a constant current power source 168 as described in U.S. patent application Ser. No. 13/722,581, which is incorporated by reference hereinabove.

As noted above, in some embodiments, the temperature sensor 136 may be a thermistor. Where it is a thermistor, the change in resistance of the thermistor may indicate to the timer 136 the change in temperature of the device the thermistor is thermally coupled thereto. As depicted in FIG. 1, the thermistor may be thermally coupled to the first light source 110, although it may be thermally coupled to any device as described hereinabove. As the resistance changes, the input to the trigger pin 138 and the threshold pin 142 will vary in response. Accordingly, as the resistance changes, the oscillation cycle of the timer 136 will vary in response. More specifically, as the resistance of the thermistor increases, a duty cycle of the oscillation cycle will decrease. Where, as in the present embodiment, the oscillation cycle of the timer 136 controls the operation of the first light source 110 via its transmittal through the discharge pin 144, a change in the duty cycle will have a corresponding effect on the operation of the first light source 110. More specifically, as the duty cycle decreases, the first light source 110 will have a corresponding decrease in operation, thus effectuating PWM dimming of the first light source 110. Accordingly, the luminous intensity of light emitted by the first light source 110 is controlled responsive to changes in temperature of the temperature sensor 136, namely, the thermistor.

In some embodiments, where the temperature sensor 136 is a thermistor, the thermistor may be selected to have a change in resistance that can be interpreted by the IC 134 to infer a corresponding reduction in luminous intensity of light emitted by the second light source 120. Where the IC 134 is a timer 136, the thermistor may be selected to as to cause the oscillation cycle that controls the operation of the first light source 110 to have a reduced duty cycle the causes the average luminous intensity of light emitted by the first light source 110 to be reduced by approximately the same inferred reduction of luminous intensity of light emitted by the second light source 120.

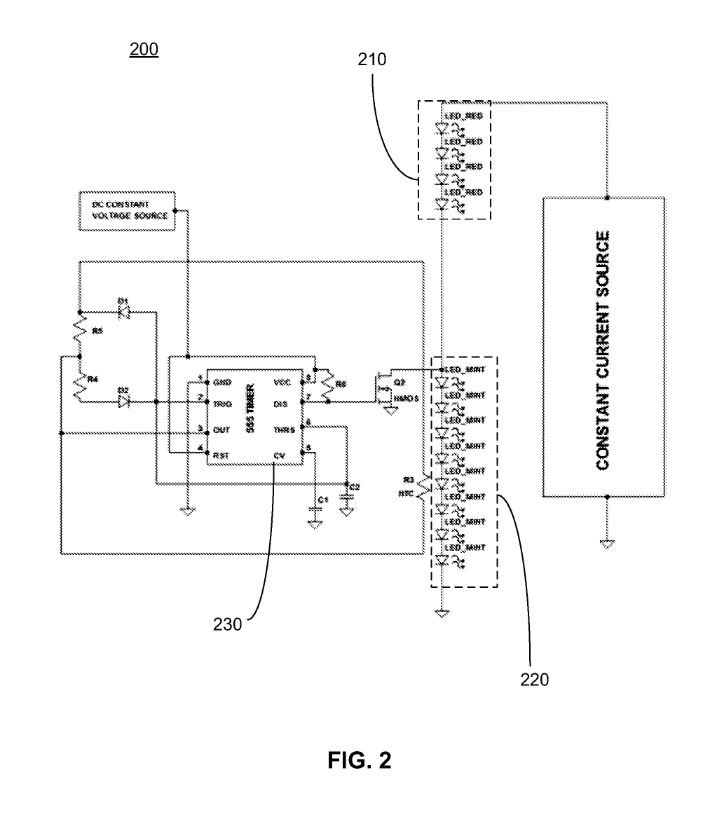

Referring now to FIG. 2, an alternative embodiment of the present invention is depicted. Shown is a lighting system 200 having a similar configuration to the lighting system 100 of FIG. 1, with the exception that the second light source 210 comes first in an electrical series, with the first light source 220 coming second. Furthermore, the circuitry enabling the IC 230, specifically the discharge pin 230, to control the operation of the first light source 220 contains different electrical components, more details of which can be found in U.S. patent application Ser. No. 13/722,581, which is incorporated by reference hereinabove.

Furthermore, it is contemplated that the above described lighting device may be incorporated into a luminaire, light bulb, or any other system or device that can facilitate the operation of the lighting device.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A lighting system for maintaining constant color output comprising:
a first light-emitting diode (LED) configured to emit a first color;
a second LED configured to emit a second color;
control circuitry configured to control the operation of the first LED;
and
a temperature sensor positioned in thermal communication with at least one of the first LED and the second LED and in electrical communication with the control circuitry;
wherein the first and second LEDs are in a serial electrical connection with each other;
wherein the luminous intensity of the second LED varies with temperature;
wherein the control circuitry is configured to control the luminous intensity of the first LED responsive to a temperature indication from the temperature sensor.

2. A lighting system according to claim 1 further comprising a circuit board; wherein each of the first LED, the second LED, and the temperature sensor are all affixed to and positioned in thermal communication with the circuit board.

3. A lighting system according to claim 1 wherein the temperature sensor is selected from the group consisting of thermistors, integrated circuit sensors, and thermocouples.

4. A lighting system according to claim 1 wherein the control circuitry comprises a timer; wherein the timer is configured to receive an input signal from the temperature sensor indicating the temperature of at least the first LED; and wherein the timer is configured to generate a signal controlling the operation of the first LED responsive to the input signal.

5. A lighting system according to claim 4 wherein the timer is configured to operate in an astable mode.

6. A lighting system according to claim 5 wherein the timer is configured to generate a PWM signal; and wherein the timer is configured to modify the PWM signal to control the luminous intensity of the first LED responsive to the input signal.

7. A lighting system according to claim 1 wherein the luminous intensity of second LED decreases predictably with an increase in temperature; and wherein the control circuitry is configured to decrease the luminous output of the first LED proportionally to a predicted decrease in luminous output of the second LED resulting from the increase in temperature indicated by the temperature sensor.

8. A lighting system according to claim 1 wherein the first LED is a mint LED; and wherein the second LED is a red LED.

9. A lighting system according to claim 8 further comprising a third LED configured to emit a third color positioned in series with the red LED.

10. A lighting system according to claim 9 wherein the third LED is a blue LED and further comprises a color conversion layer in optical communication with the blue LED.

11. A lighting system according to claim 10 wherein the color conversion layer emits a green light and is formed of a material selected from the group consisting of phosphors, quantum dots, dyes, and luminescents.

12. A lighting system according to claim 1 wherein the control circuit comprises a field effect transistor (FET) positioned electrically in parallel with the first LED.

13. A lighting system according to claim 1 wherein each of the first LED and the second LED are positioned electrically in series with a constant current power source.

14. A method of maintaining a constant color output in a lighting system having a first LED configured to emit a first color, a second LED configured to emit a second color, control circuitry configured to control the operation of the first LED, and a temperature sensor positioned in thermal communication with at least one of the first LED and the second LED and positioned in electrical communication with the control circuitry, the method comprising the steps of:
measuring a first temperature using the temperature sensor;
operating each of the first LED and the second LED;
measuring a second temperature using the temperature; and
determining whether there is a change in temperature between the first and second temperatures;
wherein a determination of a change in temperature results in operating the first LED responsive to the change in temperature.

15. A method according to claim 14 wherein the step of operating the first LED responsive to the change in temperature comprises:
determining a change in the luminous intensity of the second LED associated with the change in temperature; and
operating the first LED to have a change in luminous intensity approximately equal to the determined change in luminous intensity of the second LED.

16. A method according to claim 14 wherein the control circuitry comprises a timer configured to operate in an astable mode and positioned in electrical communication with each of the temperature sensor and the first LED, the method further comprising the steps of:
generating a first output signal controlling the luminous intensity of the first LED;
receiving at the timer an input signal from the temperature sensor; and
generating a second output signal controlling the luminous intensity of the first LED;
wherein the luminous intensity resulting from the first output signal is different from the luminous output resulting from the second output signal.

17. A lighting system according to claim 16 wherein the timer is configured to generate a PWM signal, the method further comprising the steps of:
generating a first PWM output signal configured to control the luminous intensity of the first LED;
wherein a determination of a change in temperature results in generating a second PWM output signal configured to alter the luminous intensity of the first LED compared to the luminous intensity resulting from the first PWM signal.

18. A lighting system for maintaining constant color output comprising:
a first light-emitting diode (LED) configured to emit a first color;
a second LED configured to emit a second color;
a circuit board positioned in electrical and thermal communication with each of the first and second LEDs;
a temperature sensor positioned in thermal communication with at least one of the first LED, the second LED, and the circuit board; and
control circuitry positioned in electrical communication with the temperature sensor and comprising a timer configured to receive an input signal from the temperature sensor indicating the temperature of at least the first LED and to generate a signal controlling the operation of the first LED responsive to the input signal;
wherein the first and second LEDs are in a serial electrical connection with each other;
wherein the luminous intensity of second LED decreases predictably with an increase in temperature;
wherein the control circuitry is configured to decrease the luminous output of the first LED proportionally to a predicted decrease in luminous output of the second LED resulting from an increase in temperature indicated by the temperature sensor;
wherein the control circuitry is configured to control the luminous intensity of the first LED responsive to a temperature indication from the temperature sensor.

19. A lighting system according to claim 18 wherein the first LED is a mint LED; and wherein the second LED is a red LED.

20. A lighting system according to claim 19 wherein each of the first LED and the second LED are positioned in series with a constant current power source.
